(19) United States
(12) Patent Application Publication
(10) Pub. No.: US 2011/0120644 A1
(43) Pub. Date: May 26, 2011

(54) Process of manufacturing heavy paper pulp based board

(76) Inventor: Kuo-tzu Chiu, Tianjin (CN)

(21) Appl. No.: 12/624,389

(22) Filed: Nov. 23, 2009

(51) Int. Cl. C09J 5/00

(52) U.S. Cl. 156/324

(57) ABSTRACT

A process of manufacturing heavy paper pulp based board comprising flowing liquefied starch based adhesive onto a plurality of endless, continuous, stacked paperboards; conveying the paperboards coated with the starch based adhesive to a joining line of a pair of opposite drive rolls; and conveying an endless, continuous linerboard to the joining line of the drive rolls so that the drive rolls press the linerboard, the starch based adhesive, and the paperboards from top to bottom to produce the finished heavy paper pulp based board. The heavy paper pulp based board can be further cut into desired units.

### BACKGROUND OF THE INVENTION

1. Field of Invention

The invention relates to the manufacture of heavy paper pulp based board (i.e., so-called cardboard) and more particularly to a process of manufacturing heavy paper pulp based board with improved characteristics.

2. Description of Related Art

A conventional process of manufacturing heavy paper pulp based board (i.e., so-called cardboard) comprises the steps of coating a starch based adhesive on a bottom surface of a plurality of paperboards; and heating the paperboard to a temperature in a range of 160° C. to 180° C. by urging a hot plate against the paperboards thereunder until the finished board is produced.

The coating of the starch based adhesive is on the bottom surface of the paperboards because it can facilitate the heating by the hot plate thereunder and cause the molten starch based adhesive to permeate the paperboards so that the paperboards can be glued together after drying.

However, the well known process suffers from a number of disadvantages. In detail, the paperboards are limited to a few materials not including plastic, textile, non-woven textile, synthetic paper, and synthetic leather. This is because these stronger and/or aesthetic materials cannot withstand high temperature and strong friction by the hot plate. For example, they may be deformed. Also, patterns printed on the bottom surface of the paperboards may be distorted or damaged in the heating process because it faces the hot plate. Thus, the need for improvement still exists.

### SUMMARY OF THE INVENTION

It is therefore one object of the invention to provide a process of manufacturing heavy paper pulp based board.

The above and other objects, features and advantages of the invention will become apparent from the following detailed description taken with the accompanying drawings.

### BRIEF DESCRIPTION OF THE DRAWINGS

FIG. 1 schematically depicts a process of manufacturing heavy paper pulp based board according to the invention.

### DETAILED DESCRIPTION OF THE INVENTION

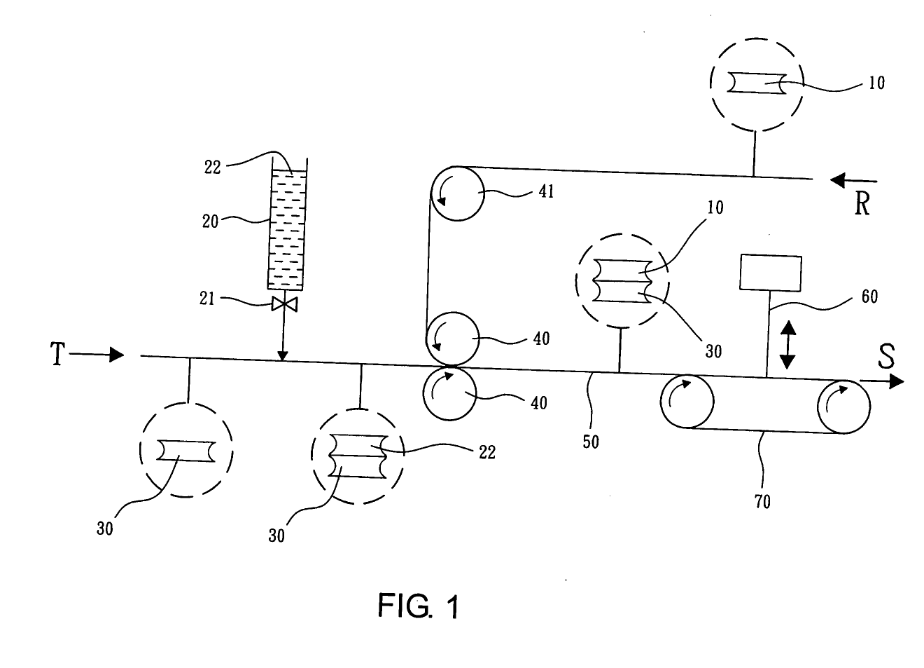

Referring to FIG. 1, a process of manufacturing heavy paper pulp based board in accordance with the invention is illustrated.

An endless, continuous linerboard 10 is conveyed by a driven roll 41 as indicated by arrow R.

Preferably, the linerboard 10 is formed of a first material selected from the group consisting of plastic, textile, non-woven textile, synthetic paper, and synthetic leather; and a second material (e.g., paper) below the first material.

At the same time, a plurality of endless, continuous, stacked paperboards 30 are conveyed in a direction as indicated by arrow T. Preferably, the paperboards 30 are heated to a temperature in a range of 80° C. to 90° C.

An employee may open a bottom valve 21 of a tank 20 to flow liquefied starch based adhesive 22 contained in the tank 20 onto a top surface of the paperboards 30 being conveyed thereunder. Preferably, the starch based adhesive 22 may easily dry in room temperature.

Next, both the paperboards 30 coated with the starch based adhesive 22 and the paperboard 10 are conveyed to a joining line of a pair of opposite drive rolls 40. Preferably, patterns printed on the linerboard 10 face upward at the joining line of the pair of opposite drive rolls 40. Each drive roll 40 has a porous canvas surface. At the joining line of the pair of opposite drive rolls 40, the linerboard 10, the starch based adhesive 22, and the paperboards 30 from top to bottom are pressed to produce a finished paperboard 50 of multi-ply with some portions of the starch based adhesive 22 being dried for adhering the linerboard 10 and the paperboards 30 together and the remaining portions thereof passing through the pores of the canvas for escape.

Advantageously, the employee may clearly see whether the patterns printed on the linerboard 10 are intact or not (i.e., not distorted or damaged) because the patterns face upward.

The finished paperboard 50 is then conveyed (as indicated by arrow S) to a cutting device 60 by a conveyor 70. The cutting device 60 may cut the finished paperboard 50 into a plurality of units of predetermined sizes.

Preferably, the number of the paperboards 30 is three. That is, paperboards 30 are comprised of a top board, an intermediate corrugation trough support, and a base board.

Still preferably, the number of the paperboards 30 is five. That is, paperboards 30 are comprised of a top board, an upper corrugation trough support, an intermediate board, a lower corrugation trough support, and a base board.

Preferably, a pattern is printed on each unit of the linerboard 10. That is, the units of the linerboard 10 are registered with the cut units of the finished paperboard 50.

The finished paperboard 50 is a heavy paper pulp based board.

While the invention herein disclosed has been described by means of specific embodiments, numerous modifications and variations could be made thereto by those skilled in the art without departing from the scope and spirit of the invention set forth in the claims.

What is claimed is:

1. A process of manufacturing a heavy paper pulp based board comprising the steps of:
(a) flowing liquefied starch based adhesive onto a plurality of endless, continuous, stacked paperboards;
(b) conveying the paperboards coated with the starch based adhesive to a joining line of a pair of opposite drive rolls; and
(c) conveying an endless, continuous linerboard to the joining line of the drive rolls so that the drive rolls press the linerboard, the starch based adhesive, and the paperboards from top to bottom to produce the finished heavy paper pulp based board.

2. The process of claim 1, wherein the linerboard is formed of a material selected from the group consisting of plastic, textile, non-woven textile, synthetic paper, and synthetic leather; and paper below the material.

3. The process of claim 1, wherein the paperboards are heated to a temperature in a range of 80° C. to 90° C. prior to step (a).
